(19) United States
(12) Patent Application Publication
(10) Pub. No.: US 2005/0276396 A1
(43) Pub. Date: Dec. 15, 2005

(54) System for assisting in the distribution of benefits, particularly of monetary allowances

(76) Inventors: Alain Bernard, Paris (FR); Keith Jentoft, Circle Pines, MN (US)

Correspondence Address: FULBRIGHT & JAWORSKI, LLP, 666 FIFTH AVE, NEW YORK, NY, 10103-3198, US

(21) Appl. No.: 11/114,832

(22) Filed: Apr. 26, 2005

(30) Foreign Application Priority Data
May 28, 2004 (FR) 04/51071

(51) Int. Cl. H04M 1/64

(52) U.S. Cl. 379/88.19; 379/88.16

(57) ABSTRACT

The invention relates to a system for the distribution of benefits to beneficiaries. It comprises a server for receiving telephone calls of beneficiaries, comprising: A module (20) for locating each caller according to the telephone signal received, A module (32) for identification of the caller, designed to find whether the identifier received by telephone from the caller corresponds to a benefiary's identifier, A module (40) for determining at least one automatic dispenser near the place of the call, and A module (40) for transmitting by telephone, particularly by voice synthesis, to the appellant the location of the automatic dispenser or group of dispensers selected, and a withdrawal authorization code in the dispenser, and for transmitting this authorization to the automatic dispenser or group of dispensers.

The invention relates to a system for assisting in the distribution of benefits, particularly of monetary allowances.

The dispensing of monetary allowances by public organizations requires costly management. In fact, it is necessary to provide a sufficient number of offices to enable the beneficiaries to withdraw their allowances without the need to travel excessively long distances. Furthermore, such distribution makes it necessary to verify the identity of the persons who come to claim their allowances and requires security measures such as are involved in any distribution of money.

The invention makes it possible in a simple and sure manner to assure the distribution of allowances.

The invention therefore relates to a system for dispensing allowances to recipients, comprising a server for receiving telephone calls from the recipients, comprising:

a module for locating each applicant according to the telephone signal received,

a module for identifying the caller, designed to find whether an identifier received by telephone from the caller corresponds to a beneficiary's identifier,

a module for selecting an automatic dispenser or group of dispensers near to the place from which the call was made, and

a module for informing the caller by telephone, particularly by voice synthesization, of the location of the automatic dispenser or group of dispensers, plus a withdrawal authorization code at that dispenser or group of dispensers, and for transmitting this authorization to the automatic dispenser or group of dispensers.

Thus the attribution of rights can be performed automatically, or largely automatically, and travel by the recipients is minimized.

The caller's identifier is, for example, an identity card given to the recipient, this identifier being preferably transmitted by an acoustical signal emitted by the card.

Preferably, the identifier is an identifier of the person of the cardholder, especially an identifier representing the caller's voice, the system then containing a voice identification module.

In this case, it is preferable to provide a module for asking the caller a question so that the latter will speak and the voice identification module can perform its function.

In one embodiment, the identification is a combination of the code of a card and an identifier of the person, such as the voice. In this last case the system preferably comprises:
a module for determining data connected with the caller according to the code connected with his card and for asking questions depending on the caller's profile, and
a module for analyzing the responses made by the caller in order to verify whether they agree with the data in memory, the granting of allowances being authorized only if the responded data agree with the data in memory.

In one embodiment the system includes a module to transfer the caller to an operator when the caller's voice has not been recognized automatically and/or when the answers given have not been recognized by the automatic analysis module.

Preferably, the operator is selected according to profile data corresponding to those associated with the caller's card.

The caller's location is determined, for example, by his telephone number when the land telephone network is involved or by the basic cell with which he is connected if a mobile telephony system is involved. If it is a question of a call coming from an IP server, the location will be determined by the IP address of the source.

In the case where the caller is owner of a card serving for identification, this card can be used for withdrawing money or other valuables in the associated automatic dispenser.

Preferably, the code that can be used for the withdrawal is valid for only one time and for a limited period, for example on the order of three days.

The invention likewise relates, according to another of its aspects which can be used independently of those mentioned above, to a system for identification of the owner of a card to which a code is assigned, which comprises, in addition to the recognition of the code, the recognition of the formants of the cardholder's voice.

Other characteristics and advantages of the invention will appear in the description of some of its embodiments, the latter being found by referring to the annexed drawing in which the single FIGURE represents a system pursuant to the invention.

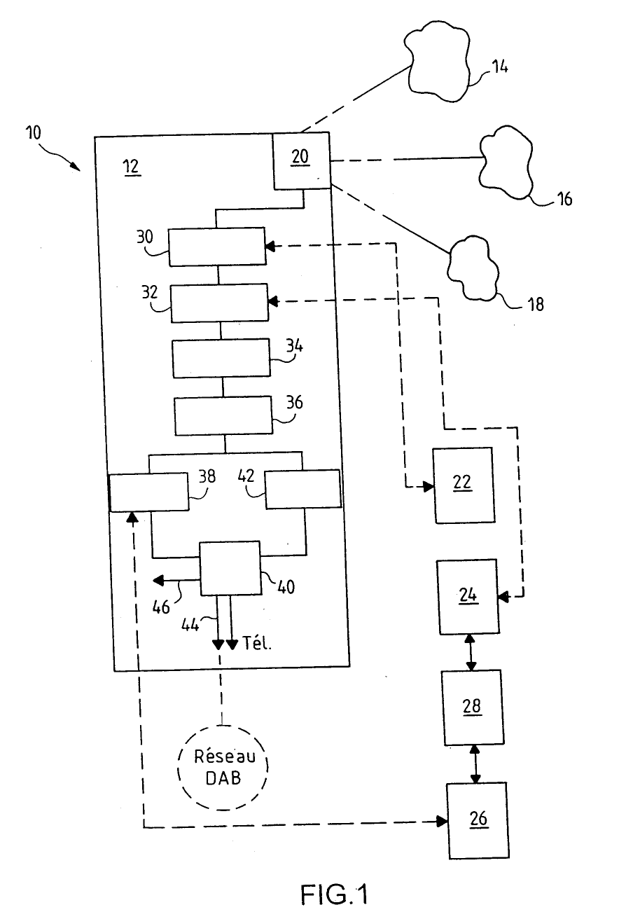

The system represented in FIG. 1 involves a processing center 10 containing an interactive voice server 12 for receiving the telephone calls coming from all types of networks, viz., a mobile telephone network 14, the fixed telephone network, and the IP voice network 18. The center 10 contains a means 20 for locating the calls, particularly by determining the location of the call such as the city, based on the caller's number in the case of the fixed telephone network 16, or the base cell in which the calling mobile telephone is situated.

The processing center 10 is coupled to a database 22 making it possible to determine the locations of telephone calls on the basis of the characteristics of the call. The processing center 10 is likewise coupled to databases relating to the entitled holder. Since a personal card with a secret-code identification number is given to each holder, for example, an acoustical code emitted by the card itself, provision is made for the center 10 also to be coupled to a database 24 containing the authorized codes.

To permit additional identification by voice signing, at the time of their registration, during which a card is sent to them, the subscribers record samples of their voice. The voice formants of the subscribers are thus recorded in a database 26. The database 24 relating to the card codes, and the database 26 of the voice formants of the subscribers, are connected to a database 28 indicating that a particular card code and particular voice formants or identifiers correspond to a particular subscriber.

Moreover, in the database 28 other information useful in identifying the subscriber is recorded, such as his date and place of birth, the date of his arrival in the territory of the country, his name and surnames, etc., as well as the rights which he can claim.

The voice server 12 thus contains a call analysis module 30 which determines, based on information in the database 22 and data received by the telephone call, the location of the call.

The server 12 also comprises a means 32 for analysis of the identifier of the card which determines, on the basis of the identifier received, viz., a secret code, whether the latter corresponds to a code located in the database 24.

If the code is in the database 24, the processing center 10 determines, by a module 34, on the basis of data in the database 28, what are the characteristics of the subscriber, i.e., his profile: identity, age, nationality, his rights, etc.

On the basis of the data supplied by the profile selection module 34, the center 10 automatically selects questions to be asked of the caller (module 36) designed to verify that the caller is the person who is normally (legally) the owner of the subscriber card. These questions are, for example, “What is your name?”, “What is your place of birth?”, etc.

Based on the answer to the question or questions, a module 38 determines whether the acoustical signature of the voice of the speaker (caller) corresponds to the one that is associated in the database 28 with the identifier of the card. The module 38 provides the signal of response to a decision module 40.

The response to the questions is also analyzed by a voice recognition module 42 which detennines whether or not the responses are those expected (age, identity, etc.).

If the signal put out by the module 38 confirms that the caller's voice corresponds to the one that is associated with the card, and if the responses supplied by module 42 are those which are expected, that is, pre-recorded, then the decision module 40 works up a secret code and selects, on the basis of data supplied by the module 30, at least one automatic bank note dispenser near the location of the call. Thus, the caller receives by voice synthesis, on the one hand the information concerning the location of the bank note dispensing, and on the other hand the code that he may use to withdraw his money.

At the same time, the authorization code is sent on a path 44 to the selected automatic dispenser or group of dispensers, this code being sent at the same time as an identifier related to the card held by the caller.

This code will permit the subscriber to withdraw, from an automatic dispenser, the sum of money to which he is entitled, if he also inserts his card into the dispenser.

If the module 38 and/or module 42 do not permit any formal identification of the caller, then the decision module 40 contains a means for transferring the call via a path 46 to an operator who will determine, based on the data which he can consult in the database 28, the questions that will enable him to decide whether or not he can do business with the subscriber.

If the answer is affirmative he will operate the module 40 to have it deliver the code and the location of an automatic bank note dispenser.

The code will be valid only for one operation and for a limited time, on the order, for example, of one to three days.

Preferably, the decision module 40 is such that it enables the selection of an operator suitable for the caller. For example, based on data furnished by the database 28, he will connect the caller to an operator who has a good knowledge of the mother tongue of this caller.

This operator has, for example, a screen on which he can consult data relating to the caller.

The system described above is particularly useful for the distribution of allowances to people that might be under criminal influences. It is designed to prevent to some extent people that might be under criminal influence from pocketing allowances without the least need for the presence of the party concerned and to arrange matters so that the effort to embezzle the allowances will be out of proportion to what they can get from it.

Generally, the automatic dispenser is intended to dispense rights or products. The products are, for example, food products.

As a variant, the questions posed by the interactive voice server are of the random type, for example general knowledge or sports.

In still another variant, the term of validity of the code and/or the amount of the allowance vary according to the degree of the certitude of recognition.

1.-9. (canceled)

10. A system for distributing benefits to beneficiaries comprising a server for receiving telephone calls from beneficiaries, said server comprising:
a call analysis module for determining the location of a caller based on telephone signal received;
a caller identification module for determining whether said caller is an authorized beneficiary by comparing an identifier received from said caller to a stored beneficiary identifier; and
a decision module for determining at least one automatic dispenser near the location of said caller, informing said caller by telephone of the location of said at least one automatic dispenser and a withdrawal authorization code, and transmitting said withdrawal authorization code to said at least one automatic dispenser if it is determined said caller is said authorized beneficiary.

11. The system of claim 1O, wherein said decision module is operable to inform said caller by voice synthesis.

12. The system of claim 10, wherein a card with a unique identifier is assigned to each beneficiary; and wherein said identifier corresponds to an identifier associated with said caller's card.

13. The system of claim 12, wherein said identifier is an accoustical signal furnished by said caller's card.

14. The system of claim 13, wherein said identififer represents a voice sample of said caller.

15. The system according to claim 14, further comprising a data identifying module for providing a question to said caller; and wherein said caller identification module is operable to perform voice identification based on said caller's voice response to said question.

16. The system of claim 15, wherein said caller identification module is operable to determine whether accoustical signature of said caller's voice correspond to said stored beneficiary identifier.

17. The system of claim 13, further comprising a data identifyihng module for providing a question to said caller; and wherein said caller identification module is operable to retrieve profile data associated with said caller from a database in response to said accoustical siganl furnished by said caller's card; wherein said data identifying module is operable to provide said question to said caller in accordance with said profile data; and wherein said caller identification module is operable to verify whether said caller is an authorized beneficiary based on said caller's voice resonse to said question.

18. The system of claim 17, wherein said caller identification module is operable to compare data associated said caller's voice response to a stored data in said database to determine if said caller is an authorized beneficiary.

19. The system of claim 15, wherein said decision module is operable to transfer said caller to an operator when said caller identification is unable to identify said caller, thereby permitting said operator to determine if said caller is an authorized beneficiary.

20. The system of claim 19, wherein said decision module is operable to select said operator in accordance with stored profile data associated with said caller's card.

21. The system of claim 19, further comprising a module for providing information relative said authorized beneficiary on a screen accessible by said operator if it is determined that said caller is said authorized beneficiary.

22. The system of claim 10, wherein said call analysis module is operable to determine the location of said caller by one of the following: said caller's telephone number when said telephone signal is received over a land telephone network; base cell to which said caller is connected when said telephone signal is received over a mobile telephone network; or an IP address when said telephone signal is received over an IP network.
